(19) United States
(12) Patent Application Publication
(10) Pub. No.: US 2021/0015132 A1
(43) Pub. Date: Jan. 21, 2021

(54) MANUFACTURING METHOD OF KABAYAKI

(71) Applicant: MEIKOSHOKUHIN Co., Ltd., Hata-gun (JP)

(72) Inventor: Hiroyuki Myojin, Hata-gun (JP)

(73) Assignee: MEIKOSHOKUHIN Co., Ltd., Hata-gun, Kochi (JP)

(21) Appl. No.: 16/711,909

(22) Filed: Dec. 12, 2019

Related U.S. Application Data
(63) Continuation of application No. PCT/JP2019/032006, filed on Aug. 15, 2019.

(30) Foreign Application Priority Data
Jul. 17, 2019 (JP) 2019-131575

(51) Int. Cl. A23L 17/00

(52) U.S. Cl. CPC A23L 17/00

(57) ABSTRACT

A manufacturing method of Kabayaki includes a hole-opening step of opening a large number of holes through firmed-up slices with skins of a catfish, an immersing step of immersing the slices with skins in a source after performing the hole-opening step, and a grilling step of grilling a surface of the slices with skins after performing the immersing step.

### FIELD OF THE INVENTION

The present invention relates to a manufacturing method of Kabayaki using catfish, particularly using Pangasius.

### BACKGROUND ART

In recent years, the price of Kabayaki of eel (spitchcock of eel) is extremely increased due to the great decrease in the fish catches of the eel fry. Thus, it is difficult for general consumers to routinely eat Kabayaki of eel. Particularly, the price of the kabayaki of the domestic eel (Japanese eel) increases remarkably.

In order to resolve such problem, various eel Kabayaki substitutes that are able to approach the eel Kabayaki in feeling of the appearance and texture are proposed. For example. Patent Document 1 proposes a manufacturing method of an eel Kabayaki like product. This manufacturing method laminates the upper side shaped product including a fish meat slice and a minced fish and the lower side shaped product including a fish meat slice and a black coloring agent, shapes the laminated products, then steams or fries the shaped product, thereafter grilles the steamed or fried product, and then applies a sauce of Kabayaki to the grilled product.

Further to such a Kabayaki substitute using the fish meat slice, eel Kabayaki like foods using the catfish that has similar texture in taste as that of the eel are recently appeared in the market. The reputation in the market with respect to this Kabayaki substitutes using the catfish is good, and thus the catfish Kabayaki is in great expected as a replacement of the eel Kabayaki because the fish catches of eel is greatly decreased.

### RELATED ART DOCUMENT

### Patent Document

Patent Document 1: Japanese Patent Publication No. 2015-062346A

### SUMMARY OF THE INVENTION

### Problem to be Solved by The Invention

However, the catfish has a very large content of collagen and thus, when it is heated, the body of the catfish will soften. As is well-known, when heating, the collagen melts and changes in quality in gelatin to become in a liquid condition at around 25° C. Thus, when the catfish is heated, since its combination organization is almost made of collagen, the combination organization becomes weak to soften the catfish body.

Therefore, when a catfish Kabayaki is produced, it is necessary to carefully process the body of the catfish to keep its shape during the grilling process because as aforementioned the combination of the catfish body becomes weak and thus the catfish body will be softened when the temperature rises. If the shape of the grilled body is collapsed, its product value will largely fall. Thus, considerable skill is necessary for the grilling process of the catfish body and it has been difficult to raise the production efficiency.

The catch of Pangasius that is a kind of the catfish is great many in Southeast Asias such as Vietnam, Cambodia and Thailand, and therefore Pangasius will be favorably used for the catfish Kabayaki from the viewpoint of supply security to the increase in the expected demand in future. However, since Pangasius has much more content of the collagen as compared to a domestic catfish (Japanese catfish), the collapse of the shape of the Kabayaki when grilled will be easily occurred than that using the domestic catfish.

Also, because, unlike an eel, the Pangasius body is thick and has much content of the collagen, there are problems that (1) it is difficult to impregnate the body with the Kabayaki source, (2) the inside of the grilled body is appeared as still white colored, and (3) an appearance and a texture (taste) of the grilled body are not preferable.

### Means to Solve the Problem

It is therefore an object of the present invention to provide a manufacturing method of Kabayaki, whereby it is possible to impregnate the inside of a grilled body of a catfish such as Pangasius with a Kabayaki source, and whereby it is possible to largely improve a delicious taste and a quality of the catfish Kabayaki.

According to the present invention, a manufacturing method of Kabayaki includes a hole-opening step of opening a large number of holes through firmed-up slices with skins of a catfish, an immersing step of immersing the slices with skins in a source after performing the hole-opening step, and a grilling step of grilling a surface of the slices with skins after performing the immersing step.

Since a large number of holes are opened through firmed-up slices with skins of a catfish, good impregnation of a Kabayaki source can be expected in the later immersing step resulting that it is possible to impregnate the inside of a grilled body of the catfish slices with the Kabayaki source and that it is possible to greatly improve a delicious taste and a quality of the catfish Kabayaki.

It is preferred that the hole-opening step includes a thrusting step of thrusting from above a large number of needle projections into the slices with skins of the catfish, using a hole-opening metal tool having the large number of needle projections with a predetermined diameter protruded from a surface, and an extracting step of extracting the thrust large number of needle projections from the slices with skins of the catfish. Because the hole-opening metal tool with a large number of needle projections is used in the hole-opening step, holes can be easily and efficiently opened through the catfish slices with skins.

It is also preferred that the extracting step includes a step of extracting the thrust large number of needle projections from the slices with skins of the catfish by holding the slices using a pressing metal tool. Thus, it is possible to prevent sticking of fish meat to the needle projections and also to prevent crumbling of the body of the slices with skins

It is further preferred that the large number of needle projections of the hole-opening metal tool are arranged to have a space of 1-2.5 cm with each other. Therefore, the impregnation of the Kabayaki source can be made more uniformly.

It is still further preferred that the manufacturing method further includes a burnt-mark providing step of forming burnt-marks on a front surface of the slices with skins before performing the hole-opening step. Thus, it is possible to prevent breakup of the holes of the surface skin in the next hole-opening step from occurring resulting that certain impregnation of the Kabayaki sauce to the slices can be expected.

It is further preferred that Pangasius is used as for the catfish. By using Pangasius that is cheap and stably available, it is possible to largely reduce the production cost of the catfish Kabayaki and to stably supply the catfish Kabayaki.

### Effect of the Invention

According to the manufacturing method of Kabayaki using a catfish of the present invention, it is possible to improve the handling of the slices with skins for preventing crumbling of its body. Also, since a large number of holes are opened through firmed-up slices with skins of the catfish, good impregnation of a Kabayaki source can be expected in the later immersing step resulting to impregnate the inside of a grilled body of the catfish slices with the Kabayaki source and to greatly improve a delicious taste and a quality of the catfish Kabayaki.

Furthermore, because the hole-opening metal tool with a large number of needle projections is used in the hole-opening step, holes can be easily and efficiently opened through the catfish slices with skins. Also, since the pressing metal tool for pressing-down the catfish slices with skins is used when a large number of needle projections of the hole-opening metal tool are extracted from the slices, it is possible to prevent sticking of fish meat to the needle projections and also to prevent crumbling of the body of the catfish slices with skins.

### BRIEF DESCRIPTION OF THE DRAWING

FIG. 1 shows a flow chart illustrating processes of the manufacturing method of Kabayaki in an embodiment according to the present invention;

FIG. 2 shows a perspective view schematically illustrating a draining metal tool on which slices with skins are placed so that the bodies (fish meats) are on top as shown in (A) or so that the skins are on top as shown in (B);

FIG. 3 shows a plane view, seen from the top, schematically illustrating the draining metal tool on which the slices with skins are placed;

FIG. A shows a perspective view schematically illustrating a configuration example of a hole-opening metal tool;

FIG. 5 shows a perspective view schematically illustrating a configuration of a pressing metal tool;

FIG. 6 shows a perspective view schematically illustrating the state when holes are opened through slices with skins using the hole-opening metal tool and the pressing metal tool;

FIG. 7 shows a sectional view schematically illustrating the state when the holes are opened through slices with skins using the hole-opening metal tool and the pressing metal tool;

FIG. 8 shows a plane view, seen from the top, schematically illustrating the state when the holes are opened through slices with skins using the hole-opening metal tool and the pressing metal tool; and

FIG. 9 shows a picture illustrating the section of cut slices of catfish (Pangasius) Kabayaki produced by the manufacturing method according to the present invention.

### DESCRIPTION OF THE PREFERRED EMBODIMENTS

Hereinafter, an embodiment of a manufacturing method of kabayaki according to the present invention will be described with reference to drawings.

In this embodiment, Pangasius that is a kind of the catfish is used. At first, slices with skins (fillets with skins) F are prepared. There are two kinds of the slices with skins F. One kind is fresh slices with skins that are processed from a fresh fish and kept in fresh or kept in a refrigerator at the temperature of +2 to +3° C. The other kind is frozen slices with skins kept in a freezer at the temperature of −20° C. When using the fresh slices with skins, since no freezing nor thawing process is performed, dripping due to the destruction of cell membrane can be prevented from occurrence and the following processes can be performed in a chilled state. As a result, it is possible to maintain the good quality of the slices with skins. On the other hand. when using the frozen slices with skins, at first, slices with skins (fillets with skins) of catfish (Pangs us for example) kept in a freezer at the temperature of −20 C. are taken out and then the frozen slices with skins are thawed in the flowing water. The size of one piece of the slices with skins is for example approximately 230 g in this embodiment, and the time for thawing the frozen slices with the skins by the flowing water is approximately ten minutes. The size of each slice with the skin may be 100 to 300 q or more. According to the thawing by means of the flowing water, a peculiar muddy odor of a freshwater fish can be removed.

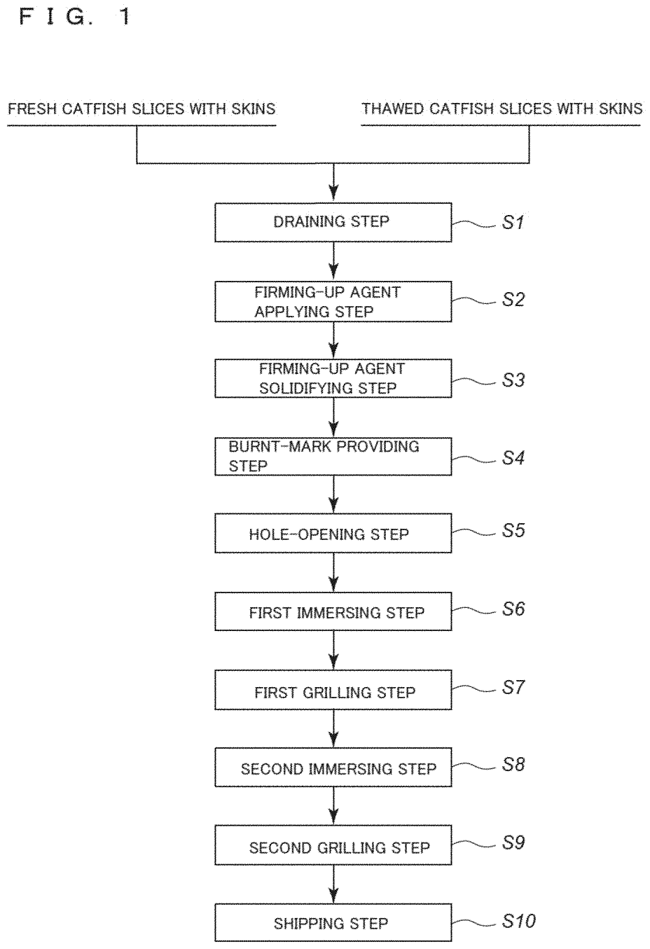

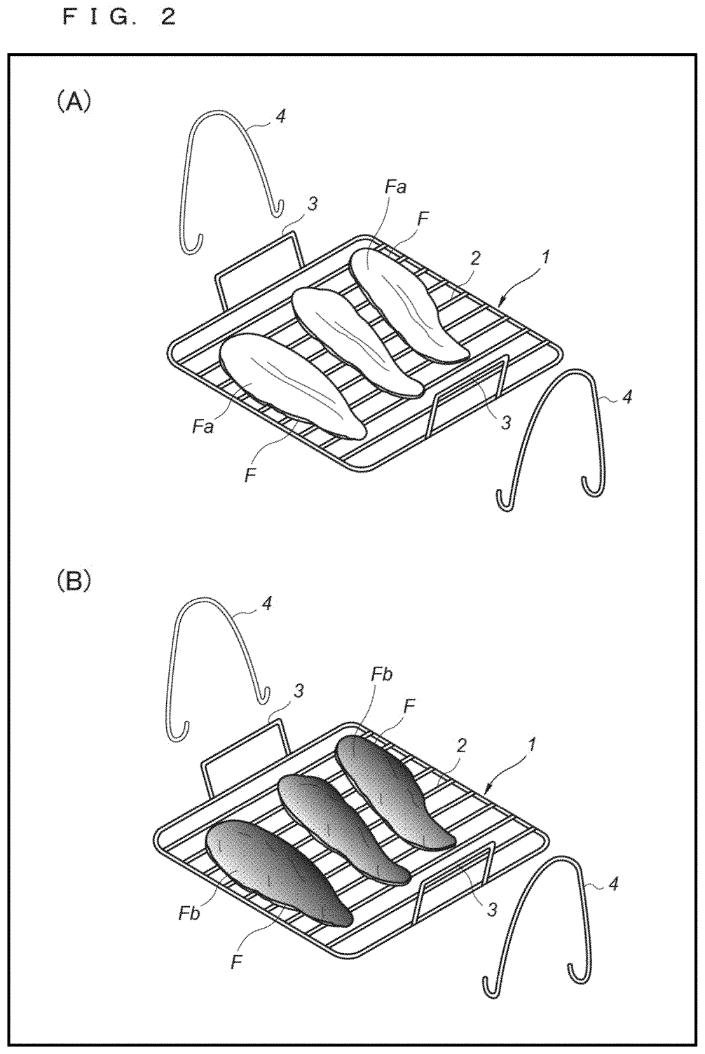

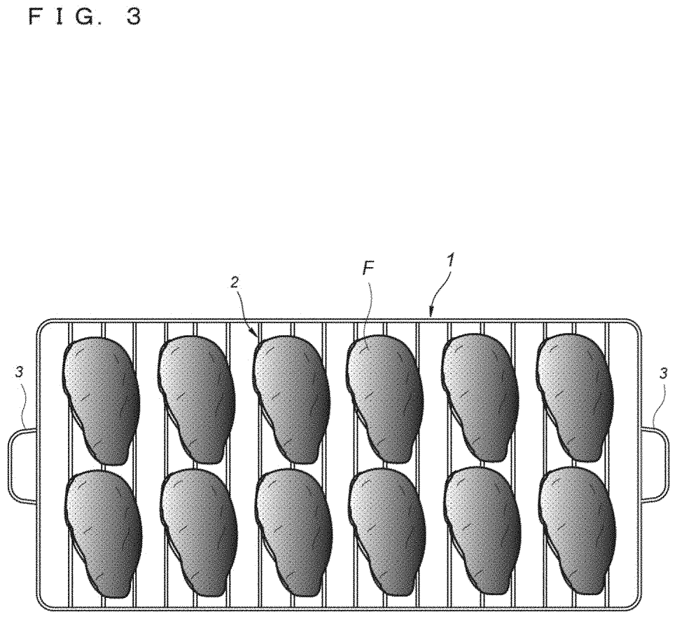

FIG. 1 is a flow chart illustrating steps of the manufacturing method of Kabayaki in an embodiment according to the present invention. As shown in FIG. 1, according to the manufacturing method of Kabayaki of this embodiment in the present invention, at first, performed is a draining step of draining fresh catfish slices with skins (or thawed catfish slices with skins) F by dipping them into a salt solution (Step S1). At this draining step, for example, a salt solution with the salinity concentration of 3 wt % is accommodated in a container or a pan, and the thawed slices with skins F are immersed in. this salt solution. The salinity concentration of the salt solution in this case will be set to a density higher than that of the catfish (for example, Pangasius) slices with skins F. That is, the salinity of the salt solution is not limited to 3 wt %, but may be 1 to 3 wt %. As known in FIG. 2(A), the plurality of slices with skins F are placed on the draining metal tool 1 (two slices are arranged along the longitudinal direction and two slices are arranged along the lateral direction) so that the slice body side Fa is on top. By arranging the slice side Fa on top, it is possible to prevent crumbling of the body of the slices with skins F due to its own weight. The draining metal tool 1 has a frame made of stainless rods with a diameter of 5 mm and provided with a longer direction width of 60 cm and a shorter direction width of 35 cm, and a plurality of stainless rods fixed to the frame with an interval of 2.5 cm to form a slice placement portion 2. Handles 3 are attached to the frame at the both side ends of the slice placement portion 2. Hooks 4 may be used to catch these handles 3 so as to carry this slice placement portion 2 even when it is heated. The slice placement portion 2 may be configured by arranging the rods in lattice form or in mesh form.

Next to the draining step (Step S1), a firming-up agent applying step of applying a firming-up agent to the drained slices is performed (Step S2). In this firming-up agent applying step, on the surface of the drained slices with skins F, the firming-up agent for preventing crumbling of the body of the slices is applied. More concretely, in this embodiment, the firming-up agent applying step is performed by accommodating in a container or a pan a suspension of a cereal powder and water (for example, a solution with 10% of rice flour), and by immersing the slices with skins F in this suspension for five minutes for example. By means of such immersing, the suspension permeates the inside of the slices with skins F and a film of the suspension is formed on the surface of the slices.

Then, a firming-up agent solidification step of solidifying the firming-up agent is performed (Step S3). In this solidification step, the firming-up agent such as the rice flour applied to the slices with skins F at the firming-up agent applying step is solidified. As shown in FIG. 2(B), at first, a plurality of the slices with skins F are placed on the draining metal tool I (two slices are arranged along the longitudinal direction and six slices are arranged along the lateral direction) so that the skin side Fb is on top. By arranging the skin side Fb on top, it is possible to improve workability of the next process. Then, the draining metal tool 1 on which a plurality of the slices with skins F are placed is dipped in a heated oil. That is, the oil is accommodated in the container or the pan and heated to a predetermined temperature (for example, 180° C.) with a heater such as gas burner, and then the slices with skins F are immersed in this heated oil. It is approximately five minutes for immersing in the heated oil. For the oil, salad oil or olive oil can re used. It should be noted that in this firming-up agent solidification step, the slice side Fa may be arranged on top so as to prevent crumbling of the body of the slices with skins F due to its own weight. However, in the latter case, before performing the next burnt mark providing step, it is necessary to turn the slices with skins F so that the skin side Fb is on top.

Then, performed is a burnt-mark providing step of forming lightly burnt-mark on the skin side Pb of the firming-up processed slices with skins F by using a gas burner (Step S4). That is, as shown in FIG. 2(B), by placing the slices with skins F after processing the firming-up process on the tool 1 so that the skin side Fb is on top, the skin side ebb is burned to form the lightly burnt-mark. For example, by using an LP gas burner, the skins are burnt at a temperature approximately around 850° C. to form a thinly burnt mark. By slightly burning the skin side Sb of the slices with skins F, it is possible to prevent breakup of the holes of the skin side Fb at the next hole-opening step from occurring resulting that certain impregnation of the Kabayaki sauce to the slices can be expected.

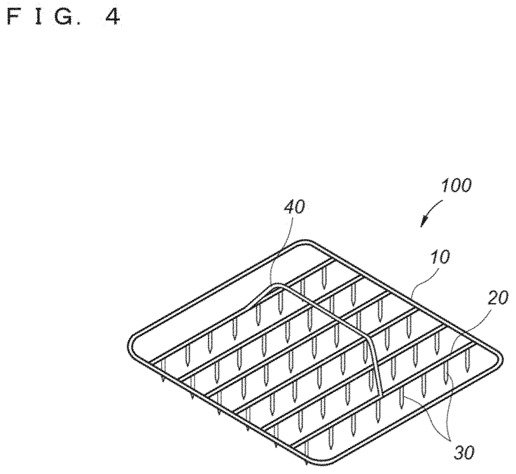

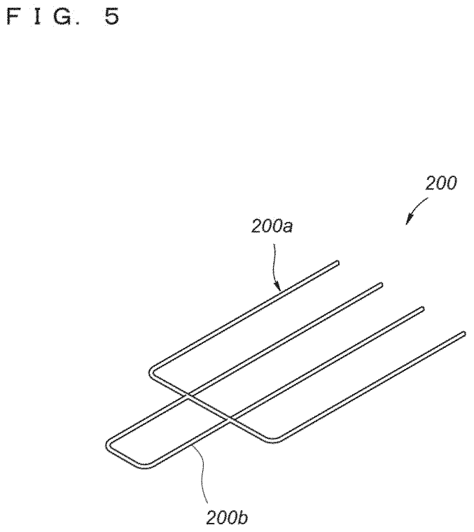

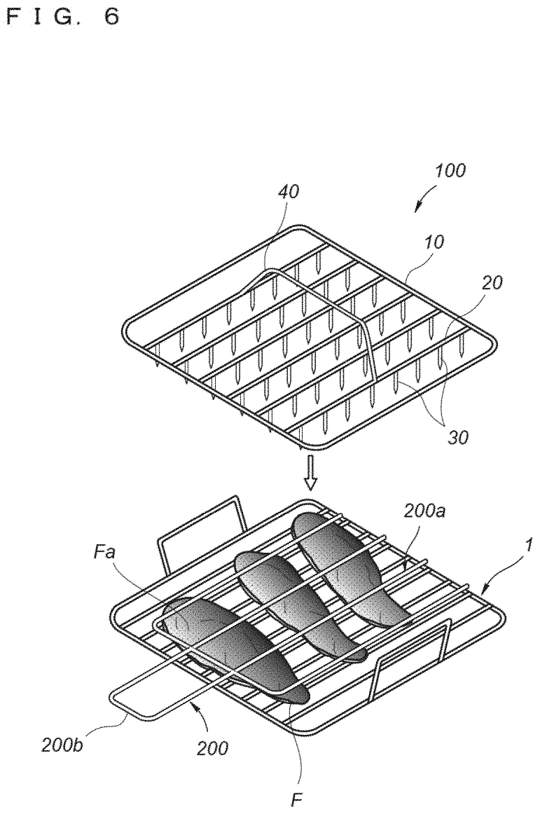

Then, the hole-opening step of forming a large number of holes through the firmed-up slices with skins F is performed (Step S5) In this hole-opening step, as shown in FIG. 3, for example, the slices with skins F with the burnt-mark are placed on the draining metal tool 1 (two slices are arranged along the longitudinal direction and six slices are arranged along the lateral direction) so that the skin side Fb is on top. Then, a hole-opening metal tool 100 shown in FIG. 4 provided with a large number of needle projections 30 is thrust into the slices with skins F, and thereafter the thrust large number of needle projections 30 are extracted from the slices with skins F. When extracting the thrust large number of needle projections 30 from the slices with skins F, a pressing metal tool 200 shown in FIG. 5 for holding the slices with skins F is used. That is, as shown in FIG. 6, before thrusting the needle projections 30 into the slices with skins F, the pressing metal tool 200 is placed on the slices with skins F. Then, the hole-opening metal tool 100 with the large number of needle projections 30 is thrust into the slices through the pressing metal tool 200.

FIG. 4 schematically illustrates the configuration. example of the hole-opening metal tool 100 used in the hole-opening step. As shown in FIG. 4, the hole-opening metal tool 100 of this embodiment has a frame 10 made of stainless rods with a diameter of 5 mm, a plurality of stainless rods 20 fixed to the frame 10 with an interval of 2.5 cm, and the plurality of needle projections 30 with an interval of 2 cm formed on one side of the plurality of stainless rods 20. Each of the plurality of needle projections 30 is formed, for example, of a stainless steel rod with a length of 4 cm and a diameter at the root of 3 mm. Tip of this rod is shaped in needle. The plurality of needle projections 30 of this hole-opening metal tool 100 are arranged with an interval of 1-2.5 cm.

FIG. 5 illustrates a configuration of the pressing metal tool 200. As shown in FIG. 5, the pressing metal tool 200 has a pressing portion 200a for pressing-down the slices with skins F and a carrying portion 200b formed on the hand side of the pressing portion 200a and held in the hand. For example, the pressing portion200a is configured from four stainless rods with a diameter of ϕ 3 mm arranged in parallel. with an interval of 5 cm. The carrying portion 200b is the handle for mainly carrying in the hand, foamed by bending a stainless rod in a rectangular shape and fixed by welding to the near side of the pressing portion 200a.

FIG. 6 illustrates the state when holes are opened through the slices with skins using the hole-opening metal tool 100 and the pressing metal tool 200. As shown in FIG. 6, in the hole-opening step, the pressing metal tool 200 is first placed oil the slices with skins F and then a large number of needle projections 30 of the hole-opening metal tool 100 are thrust from above into the slices with skins F trough the pressing metal tool 200.

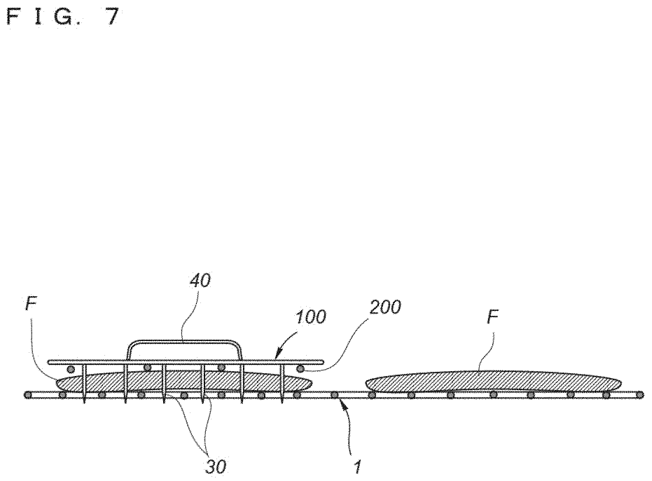

FIG. 7 illustrates in section the state when the holes are opened through the slices with skins using the hole-opening metal tool 100 and the pressing metal tool 200. As shown in FIG. 7, a large number of needle projections 30 of the hole-opening metal tool 100 are thrust from above into the slices with skins F to pass there through. The pressing metal tool 200 is positioned between the top surface of the slices with skins F and the hole-opening metal tool 100. When the large number of needle projections 30 of the hole-opening metal tool 100 are extracted from the slices with skins F, the hole-opening metal tool 100 is upwardly pulled out while the pressing metal tool 200 presses the slices with skins F, so that a large number of holes can be opened without introducing crumbling of the body of the slices with skins F.

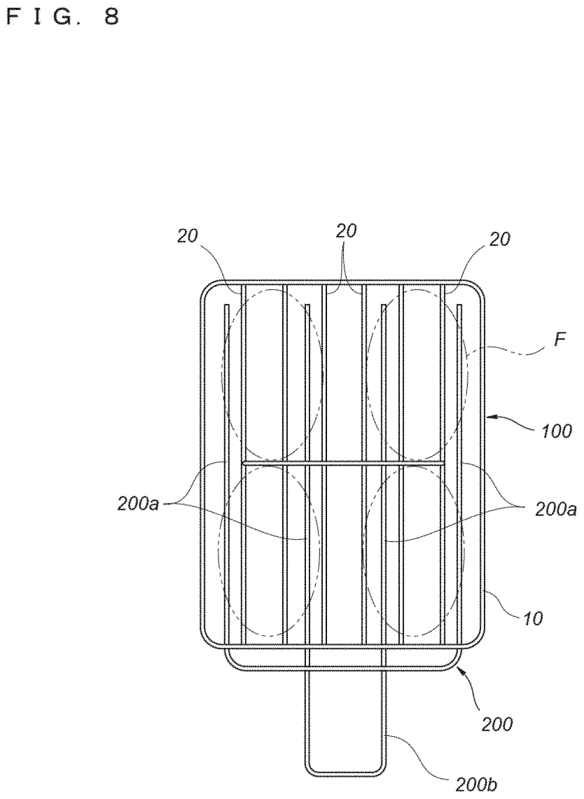

FIG. 8 illustrates the state when the holes are opened through the slices with skins F, seen from the top, wherein the hole-opening metal tool 100 and the pressing metal tool 200 are overlapped with each other. As shown in FIG. 3, when opening the holes through the slices with skins F, the pressing metal tool 200 is arranged on the slices with skins F, and a large number of needle projections 30 of the hole-opening metal tool 100 are thrust from above into the slices with skins F. According to the hole-opening metal tool 100 of this embodiment, the holes can be made for four slices with skins F at one time.

Then, a first immersing step of immersing the food namely the slices with skins F after the hole-opening step is finished, in a Kabayaki sauce is performed (Step S6). In this first immersing step, the draining metal tool 1 on which the slices with skins F are arranged is set in the container containing the Kabayaki sauce, using the hooks 4, so as to immerse the slices with skins F in the Kabayaki sauce. This sauce immersion is performed for approximately ten minutes.

Then, a first grilling step of grilling one side of the source-immersed slices with skins F is performed (Step S7). In this first grilling step, the draining metal tool 1 on which the slices with skins F is arranged is set in the empty container so that the skin side Fb of the slices with skins F is on top, and grilled by using a gas burner. This process of grilling the one side of the slices with skins F is performed for approximately three minutes. The means of grilling the slices with skins F is not limited to the gas burner but any means capable of appropriately grilling the surface of the slices with skins F may be used.

Thereafter, a second immersing step of immersing the slices with skins F, after the first grilling step is finished, in a finishing sauce is performed (Step S8). In this second immersing step, the draining metal tool 1 on which the slices with skins F is arranged is set in the container containing the finishing sauce so as to immerse the slices with skins F in the finishing sauce. This second immersing step is performed for approximately ten minutes as well as the first immersing step.

Then, a second grilling step of grilling the other side of the source-immersed slices with skins F is performed (Step S9). In this second grilling step, the draining metal tool 1 on which the slices with skins F is arranged is pulled up from the container with the finishing source, then set in the empty container, and the slice body side Fa of the slices with skins F is grilled by using the gas burner. This second grilling step is a process of grilling the other side of the slices with skins F and performed for approximately three minutes as well as the first grilling step. The means of grilling the slices with skins F is not limited to the gas burner but any means capable of appropriately grilling the surface of the slices with skins F may be used.

Finally, a shipping step is performed (Step S10). In this shipping step, the slices with skins F after processed in the second grilling step are placed on a normal temperature stand to left in the normal temperature environment so as to radiate the heat for cooling. This cooling in the normal temperature environment is performed for approximately eight minutes. Then, the slices with skins F cooled at the normal temperature are put in a bag for vacuum packaging. The finishing sauce is poured into this bag, and then vacuum packaging of the slices with skins in the bag is performed. Then, the vacuum packaged bag with the slices with skins F is heated in hot water at the temperature of 85° C. for 15 minutes. By performing this process, it is possible to effectively impregnate the slices with skins F with Kabayaki sauce, and also to sterilize the slices with skins F resulting to ensure the hygiene management of the product. Then, the vacuum packaged bag is cooled off with spring water. Thereafter, the packaged bag is frozen at the temperature of −35° C. or less, and then kept in the freezer at the temperature of −25° C. or less and shipped.

A degree of impregnation of the Kabayaki sauce with respect to thus manufactured catfish Kabayaki was measured and evaluated using a chromaticity measuring method. The following Table shows the comparison results of the catfish Kabayaki fabricated according to the manufacturing method of the present invention and the catfish Kabayaki fabricated according to the conventional manufacturing method. A plurality of Samples of the manufactured catfish Kabayaki were prepared and obliquely cut for evaluating the impregnation of the source. The impregnation degree of the Kabayaki source was measured by measuring the chromaticity of the cut sections of the Samples. The chromaticity measurement was performed by using a color chromaticity meter (CR-400 type made in Konica Minolta Co., Ltd.). The measurement of each of the Samples was done at room temperature. The chromaticity was measured at thirteen points for the Sample 1, at twelve points for the Sample 2, at twelve points for the Sample 3, at fourteen points for the Sample 4, and at fourteen points for the Sample of comparative example. Then, average values of the measured chromaticity were calculated.

TABLE

| | Average Values | | |
|---|---|---|---|
| | L | a | b |
| | White | Red | Yellow |
| Sample | Level | Level | Level |
| Sample 1 | 72.28 | 0.82 | 12.59 |
| Sample 2 | 64.75 | 3.04 | 18.21 |
| Sample 3 | 63.47 | 2.11 | 17.14 |
| Sample 4 | 60.48 | 3.20 | 16.83 |
| Sample of | 74.47 | 0.20 | 8.90 |
| Comparative | | | |
| Example | | | |

In the Table, the reference L indicates a white level, wherein pure white is the level 100, and let black is level 0. The reference a indicates a red level, wherein if the chromaticity is strong, the red level becomes high, and if the red level becomes low, the chromaticity approaches green. The reference b indicates a yellow level, wherein. if the chromaticity is strong, the yellow level becomes high, and if the yellow level becomes low, the chromaticity approaches blue. Since the Sample 1 has no hole thrust by the needle projections 30 on the cut surface, the measured red level and the measured yellow level were relatively low.

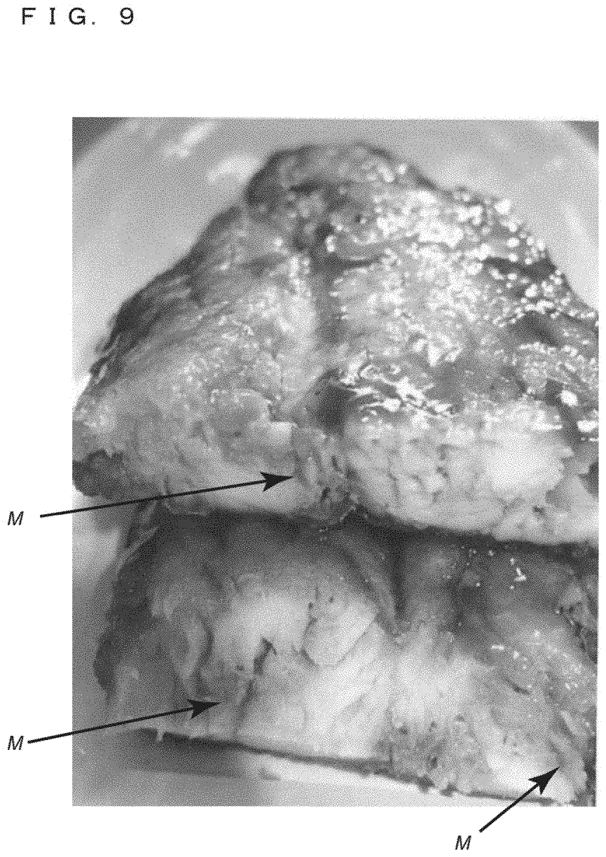

As shown in Table, Samples 1-4 of the Kabayaki fabricated by the manufacturing method according to the present invention indicate a lower white level and higher red and levels, than the Sample of the Kabayaki (comparative example) fabricated by the conventional manufacturing method. This result represents that much Kabayaki source is impregnated in the Kabayaki fabricated y the manufacturing method of the present invention. On the contrary, the Sample of the Kabayaki (comparative example) fabricated by the conventional manufacturing method indicates high white level and low red and yellow levels. This result represents that Kabayaki source is hardly impregnated in this Kabayaki. FIG. 9 illustrates the section of cut slices of catfish (Pangasius) Kabayaki produced by the manufacturing method according to the present invention. As shown in FIG. 9, the Kabayaki sauce is impregnated through the opened holes (as shown by arrows in the figure).

As discussed above, in this embodiment, since the slices with skins F of catfish (for example, Pangasius) is drained by dipping them in a salt solution having a salinity concentration higher than that in the slices with skins F, the slices with skins is firmed. Also, since the firming up agent is applied to the drained slices, with skins F and then the firming-up agent applied is solidified, it is possible to prevent crumbling of the body of the slices with skins F resulting to improve the subsequent handling of the slices with skins F. Furthermore, since a large number of holes are opened through the slices with skins F, good impregnation of a Kabayaki source can be expected in the immersing step resulting that it is possible to impregnate the inside of a grilled body of the catfish slices with the Kabayaki source and that it is possible to greatly improve a delicious taste and a quality of the catfish Kabayaki. Therefore, according to this embodiment, the productivity of the catfish Kabayaki as the replacement of the eel Kabayaki can be improved regardless of the difference of the domestic catfish (catfish of Japan) and the imported catfish.

Also, since the hole-opening metal tool 100 with a large number of needle projections 30 is used in the hole-opening step, holes can be easily and efficiently opened through the catfish slices with skins F. Furthermore, according to this embodiment, the pressing metal tool 200 for pressing-down the catfish slices with skins F is used when a large number of needle projections 30 of the hole-opening metal tool 100 are extracted from the slices. Thus, it is possible to prevent sticking of fish meat to the needle projections 30 and also to prevent crumbling of the body of the catfish slices with skins F.

In the aforementioned embodiment, the skin side Pb of the slices with skins F is on top and grilled by using the gas burner in the first grilling step and the slice body side Fa of the slices with skins F is on top and grilled by using the gas burner in the second grilling step. However, the manufacturing method of the present invention is not limited to this order of the grilling steps but the reverse order of the grilling steps may be performed.

Also, in the aforementioned embodiment, the hole-opening metal tool 100 is configured by the frame 10 made of stainless rods with a diameter of 5 Tran, the plurality of stainless rods 20 fixed to. the frame 10 with an interval of 2.5 cm, and the plurality of needle projections 30 formed on. one side of the plurality of stainless rods 20. However, the hole-opening metal tool according to the present invention is not limited to this configuration. For example, the hole-opening metal tool may be configured by a. plane plate made of wood material, resin material. or metal material, and a plurality of needle projections formed on one side of the plane plate.

Many widely different embodiments of the present invention may be constructed without departing from the spirit and scope of the present invention. It should be understood that the present invention is not limited to the specific embodiments described in the specification, except as defined in the appended claims.

### INDUSTRICAL APPLICABILITY

The present invention is applicable to a manufacturing method of a fish grilled with Teriyaki sauce, including catfish Kabayaki, particularly Pangasius Kabayaki.

### DENOTATION OF REFERENCE NUMERALS

1: draining metal tool
2: slice placement portion
3: handle
4: hook
10: frame
20: stainless rod
30: needle projections
100: hole-opening metal tool
200: pressing metal tool
200a: pressing portion
200b: carrying portion
F: slices with skins
Fa: slice body side
Fb: skin side

1. A manufacturing method of Kabayaki, comprising:
a hole-opening step of opening a large number of holes through firmed-up slices with skins of a catfish;
an immersing step of immersing the slices with skins in a source after performing said hole -opening step; and
a grilling step of grilling a surface of the slices with skins after performing said immersing step.

2. The manufacturing method of Kabayaki as claimed in claim 1, wherein said hole-opening step comprises a thrusting step of thrusting from above a large number of needle projections into said slices with skins of the catfish, using a hole-opening metal tool having said large number of needle projections with a predetermined diameter protruded from a surface; and an. extracting step of extracting the thrust large number of needle projections from said slices with skins of the catfish.

3. The manufacturing method of Kabayaki as claimed in claim 2, wherein said extracting step comprises a step of extracting said thrust large number of needle projections from said slices with skins of the catfish by holding said slices using a pressing metal tool.

4. The manufacturing method of Kabayaki as claimed in claim 2, wherein said large number of needle projections of said hole-opening metal tool are arranged to have a space of 1-2.5 cm with each other.

5. The manufacturing method of Kabayaki as claimed in claim 1, wherein said manufacturing method further comprises a burnt-mark providing step of forming burnt-marks on a front surface of the slices with skins before performing said hole-opening step.

6. The manufacturing method of Kabayaki as claimed in claim 1, wherein Pangasius is used as for the catfish.
